(19) United States
(12) Patent Application Publication
(10) Pub. No.: US 2009/0167551 A1
(43) Pub. Date: Jul. 2, 2009

(54) STATUS COMMUNICATION SYSTEM FOR ATTACHMENT TO AN ELECTRICAL DISTRIBUTION OR EQUIPMENT CONTROL BOX AND ASSOCIATED METHODS

(76) Inventor: Stanley F. Allina, JR., North Palm Beach, FL (US)

Correspondence Address: GREENBERG TRAURIG, LLP, MET LIFE BUILDING, 200 PARK AVENUE, NEW YORK, NY, 10166, US

(21) Appl. No.: 11/965,912

(22) Filed: Dec. 28, 2007

(51) Int. Cl. G08B 23/00

(52) U.S. Cl. 340/693.9

(57) ABSTRACT

One embodiment of the present invention relates to a status communication system associated with an electrical distribution/equipment control box having a case portion and a movable lid portion, comprising: a body; a status communicator attached to the body; a communication element having at least a first end and a second end, wherein the first end of the communication element is operatively connected to the status communicator; and an attachment mechanism; wherein the second end of the communication element is operatively connected to a status communicator driving mechanism inside of the case portion of the electrical distribution/equipment control box; wherein a part of the communication element is disposed between the case portion of the electrical distribution/equipment control box and the moveable lid portion of the electrical distribution/equipment control box when the communication element is operatively connected to the status communicator and the status communicator driving mechanism and the moveable lid portion of the electrical distribution/equipment control box is in a closed position on the case portion of the electrical distribution/equipment control box; and wherein the attachment mechanism attaches the body to the electrical distribution/equipment control box at a position such that a state of the status communicator can be discerned by a person without opening the movable lid portion of the electrical distribution/equipment control box.

### FIELD OF THE INVENTION

One embodiment of the present invention relates to a status communication system for attachment (e.g., a removable attachment) to, for example, a movable lid of to an electrical distribution/equipment control box (e.g., a watt-hour meter enclosure).

Another embodiment of the present invention relates to a method of using a status communication system attached (e.g., a removably attached) to, for example a movable lid of an electrical distribution/equipment control box (e.g., a watt-hour meter).

Another embodiment of the present invention relates to a method of making a status communication system for attachment (e.g., a removable attachment) to, for example, a movable lid an electrical distribution/equipment control box (e.g., a watt-hour meter).

For the purposes of describing and claiming the present invention, the term “status” (e.g., as used in connection with “status indicator”) may refer to on-off status or may refer to various levels of status (e.g., high-medium-low). It may also refer to a bi directional communication status.

Further, for the purposes of describing and claiming the present invention, the term “lid” is intended to include cover, door and the like.

### BACKGROUND OF THE INVENTION

Conventionally, to gain access to a device inside of an electrical distribution/equipment control box, holes are typically drilled in the electrical distribution/equipment control box and weather resistant compounds and/or connectors must then be applied. This procedure is typically time consuming, costly and complex. Additionally, drilling holes, in some instances, may violate box certifications and/or possibly even local and national codes (that is, box specifications may prohibit penetration of the electrical distribution/equipment control box).

Other conventional methods involve sophisticated, costly, RF transmission and magnetic coupling.

### BRIEF DESCRIPTION OF THE DRAWINGS

FIGS. 1A and 1B show a status communication system according to an embodiment of the present invention (FIG. 1A is a generally top perspective view and FIG. 1B is a generally bottom perspective view);

FIGS. 2A and 2B show attachment to an electrical distribution/equipment control box of a status communication system according to an embodiment of the present invention (FIG. 2A is a generally top perspective view and FIG. 2B is a frontal plan view);

FIG. 3 shows a perspective view of a smaller variation status communication system according to an embodiment of the present invention;

FIGS. 4A-4F show a status communication system according to an embodiment of the present invention (FIG. 4A is a top plan view; FIG. 4B is a bottom plan view; FIG. 4C is a side view; FIG. 4D is an end view; FIG. 4E is a perspective view generally of the bottom from one end; and FIG. 4F is a perspective view generally of the bottom from the other end);

FIGS. 5A-5G show a status communication system according to an embodiment of the present invention (FIG. 5A is a top plan view; FIG. 5B is a bottom plan view; FIG. 5C is a side view; FIG. 5D is one end view; FIG. 5E is another end view; FIG. 5F is a perspective view generally of the bottom from one end; and FIG. 5G is a perspective view generally of the top from the other end);

FIGS. 6-8 show various views of a status communication system according to an embodiment of the present invention;

FIGS. 9 and 10 show various views of a status communication system according to an embodiment of the present invention;

FIG. 11 shows various views of unassembled and assembled components of a status communication system according to an embodiment of the present invention;

FIG. 12 shows a plan view the status communication system of FIG. 11;

FIG. 13 shows attachment to an electrical distribution/equipment control box of a status communication system according to an embodiment of the present invention;

FIG. 14 shows attachment to an electrical distribution/equipment control box of a status communication system according to an embodiment of the present invention; and

FIG. 15 shows a clip used in the attachment to an electrical distribution/equipment control box of a status communication system according to an embodiment of the present invention.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, any figures are not necessarily to scale, some features may be exaggerated to show details of particular components. In addition, any measurements, specifications, company names and the like are intended to be illustrative, and not restrictive. Therefore, specific structural and functional details disclosed herein are not to be interpreted as limiting, but merely as a representative basis for teaching one skilled in the art to variously employ the present invention.

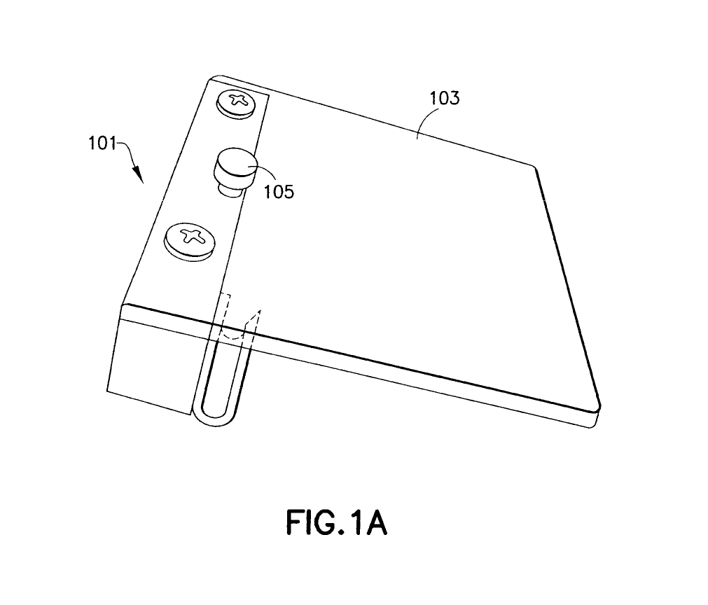

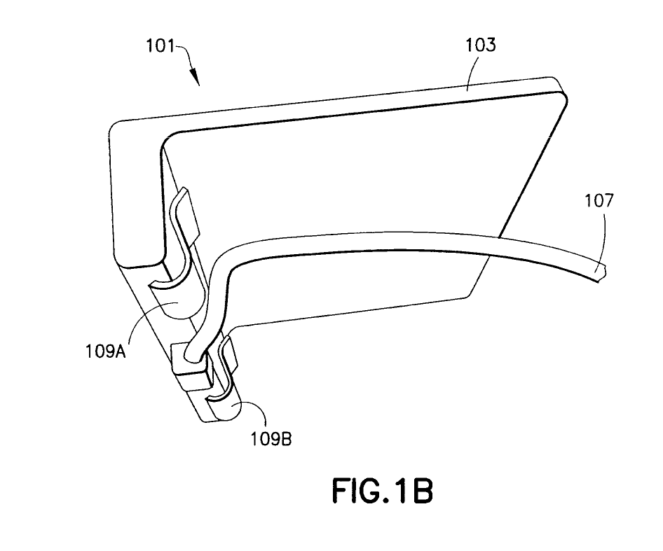

Reference will now be made to FIGS. 1A and 1B, showing one embodiment of the present invention. As seen in these Figs., a status communication system 101 (associated with an electrical distribution/equipment control box having a case portion and a moveable lid portion) may be provided. More particularly, a body 103, made of one or more pieces, may have a status communicator 105 attached thereto (while this example shows one status communicator, any desired number and type of status communicators(s) may be utilized). A communication element 107 may have at least a first end and a second end. The first end of the communication element 107 may be operatively connected to the status communicator 105 (e.g., connected using electricity, connected using visible light, connected using infra-red light, a fluid connection, a gas connection). In addition, a second end of the communication element 107 may be operatively connected (e.g., connected using electricity, connected using visible light, connected using infra-red light, a fluid connection, a gas connection) to a status communicator driving mechanism inside of the case portion of the electrical distribution/equipment control box.

Of note, a part of the communication element 107 may be disposed between the case portion of the electrical distribution/equipment control box and the movable lid portion of the electrical distribution/equipment control box when the communication element 107 is operatively connected to the status communicator 105 and the status communicator driving mechanism and the move able lid portion of the electrical distribution/equipment control box is in a closed position on the case portion of the electrical distribution/equipment control box (e.g., the communication element 107 may be disposed in a gap between the case portion of the electrical distribution/equipment control box and the moveable lid portion of the electrical distribution/equipment control box).

Of course, the communication element may be sufficiently thin to permit the moveable lid portion of the electrical distribution/equipment control box to form a substantially weather resistant seal with the case portion of the electrical distribution/equipment control box when the communication element is disposed between the case portion of the electrical distribution/equipment control box and the moveable lid portion of the electrical distribution/equipment control box (such a substantially weather resistant seal may be aided by use, for example, of weather stripping, overlap, labyrinth or the like at the interface between the case portion of the electrical distribution/equipment control box and the moveable lid portion of the electrical distribution/equipment control box).

Of further note, an attachment mechanism 109A, 109B (which is shown in these Figs. as a pair of spring-like clips but which may comprise any desired mechanism) attaches the body 101 to the electrical distribution/equipment control box at a position such that a state of the status communicator 105 can be discerned by a person without opening the movable lid portion of the electrical distribution/equipment control box.

In one example, the body may be formed at least in part from plastic polymers. In another example, the body may be formed entirely from plastic polymers. In another example, the body may be formed at least in part from metal and/or glass. In another example, the body may be formed entirely from metal and/or glass.

In another example, the status communicator outputs visible light. In another example, the status communicator outputs infra-red light. In another example, the status communicator outputs radio frequency. In another example, the status communicator outputs sound. In another example, the status communicator outputs vibration. In another example, the status communicator outputs pressure. In another example, the status communicator outputs smell. In another example, the status communicator outputs a trigger signal (e.g., an electrical, visible light, or infra-red light signal for triggering or operating another device). In another example, any combination of the above may be used.

In another example, the communication element comprises at least one electrical wire (e.g., a thin wire). In another example, the communication element comprises at least one fiber optic cable. In another example, the communication element comprises at least one light pipe. In another example, the communication element comprises a circuit board (e.g., a flexible circuit board). In another example, the communication element comprises a hollow tube. In another example, any combination of the above may be used.

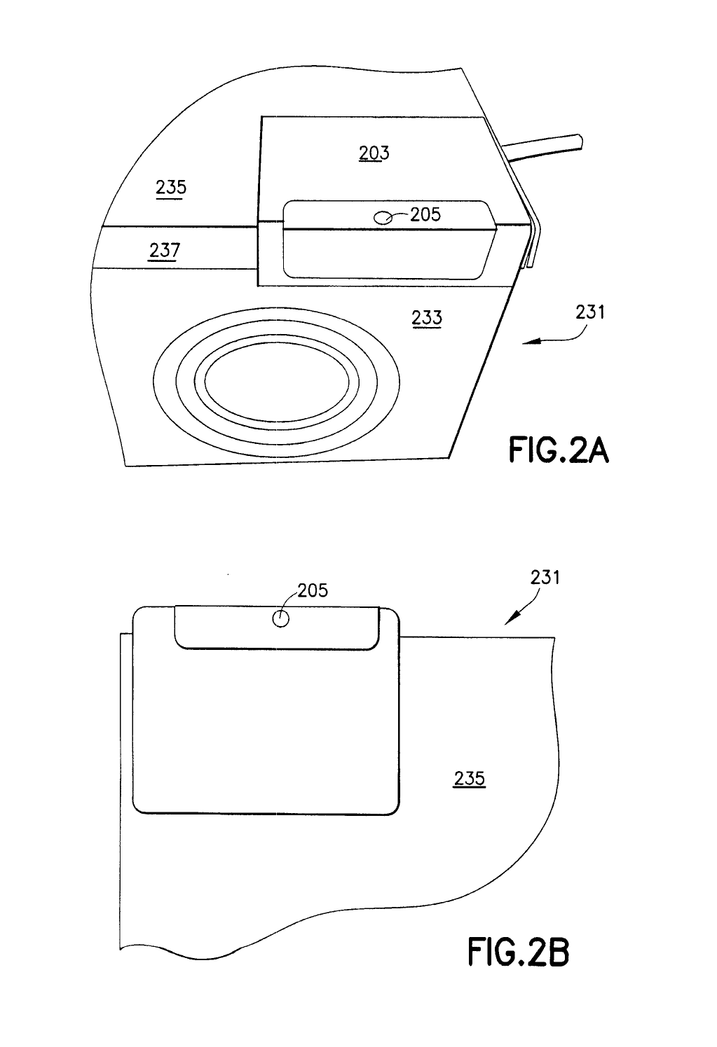

Referring now to FIGS. 2A and 2B, an example of attachment to an electric meter box is shown. More particularly, as seen in these Figs., electric meter box 231 (only a portion of which is shown) may comprise a case portion 233 and a lid portion 235. Further, lid portion 235 may include lip 237. In this example, the body 203 of the status communication system (including status communicator 205) may be attached via one or more attachment mechanisms to the lip 237 of the lid portion 235 of the electric meter box 231.

In one example, the attachment mechanism may comprise one or more clips. In another example, the attachment mechanism may comprise one or more adhesives. In another example, the attachment mechanism may comprise one or more threaded fasteners. In another example the attachment may be magnetic. In another example, the attachment mechanism may comprise any combination of the above.

In another embodiment, a method for communicating a status of a device disposed at least partially inside an electrical distribution/equipment control box having a case portion and a moveable lid portion may be provided, comprising: providing a body having a status communicator attached to the body; operatively connecting a communication element between the status communicator and a status communicator driving element inside of the case portion of the electrical distribution/equipment control box, wherein a first end of the communication element is operatively connected to the status communicator and a second end of the communication element is operatively connected to the status communicator driving mechanism; and attaching the body to the electrical distribution/equipment control box; wherein a part of the communication element is disposed between the case portion of the electrical distribution/equipment control box and the moveable lid portion of the electrical distribution/equipment control box when the communication element is operatively connected to the status communicator and the status communicator driving mechanism and the moveable lid portion of the electrical distribution/equipment control box is in a closed position on the case portion of the electrical distribution/equipment control box; and wherein the body is attached to the electrical distribution/equipment control box at a position such that a state of the status communicator can be discerned by a person without opening the moveable lid portion of the electrical distribution/equipment control box.

Reference will now be made to FIG. 3, which shows a status communication system according to another embodiment of the present invention. As seen in this Fig., body 303 may include one aperture 305 for holding therein one status communicator (not shown).

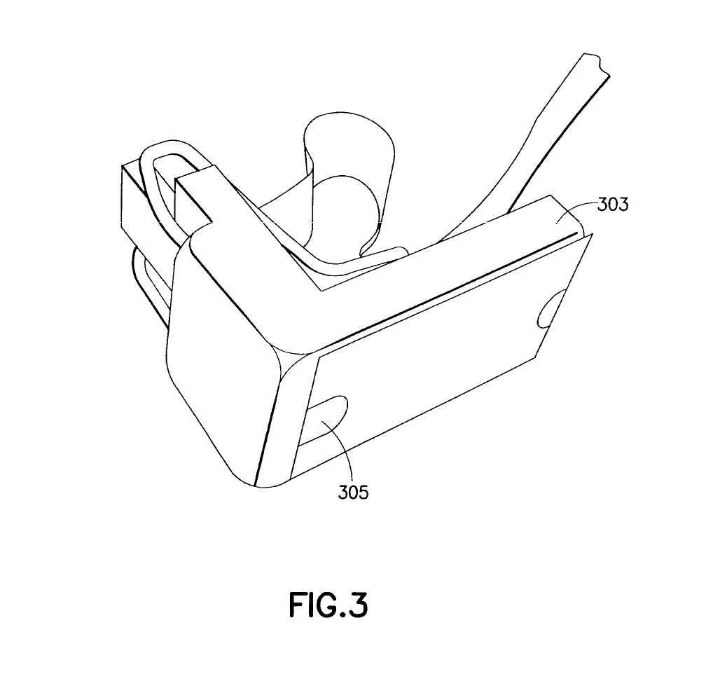

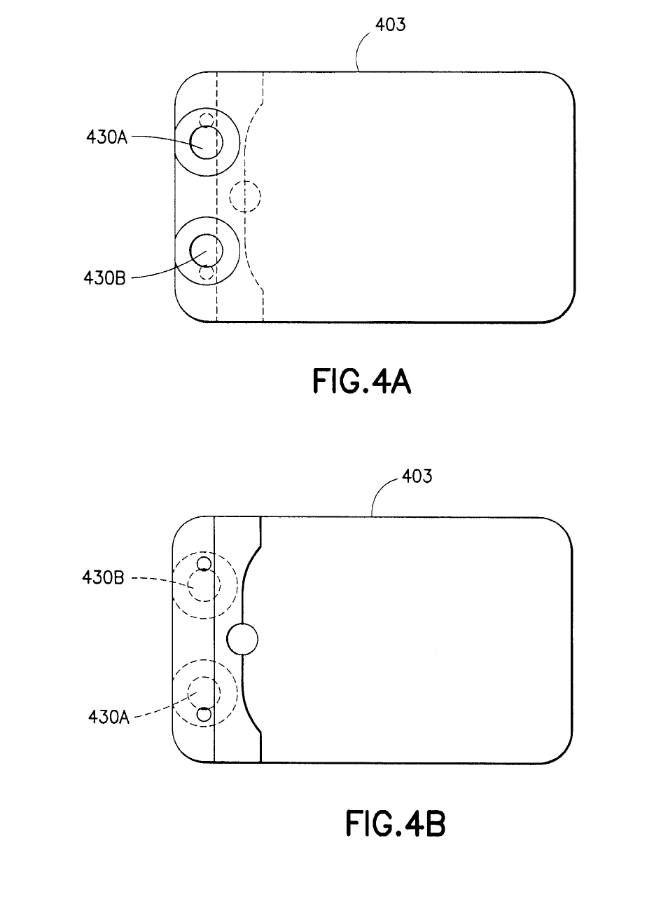

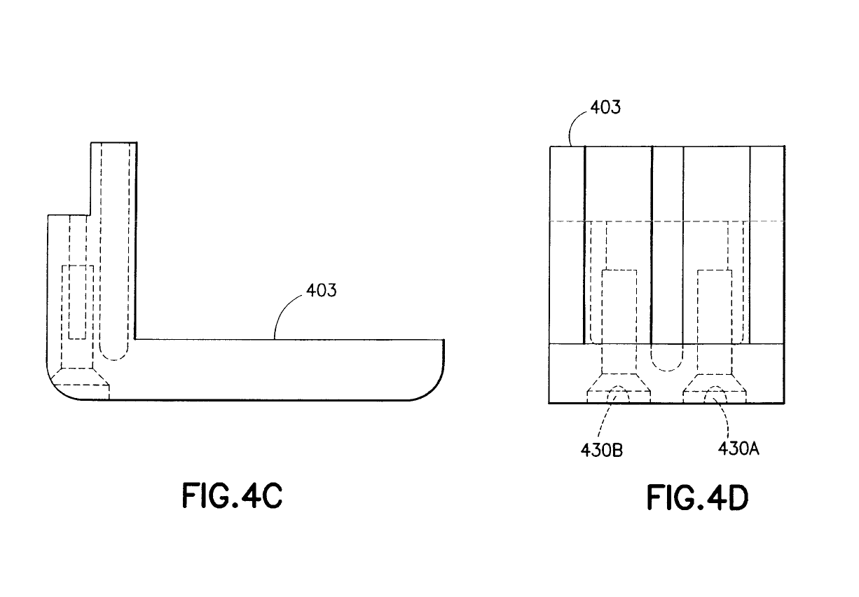

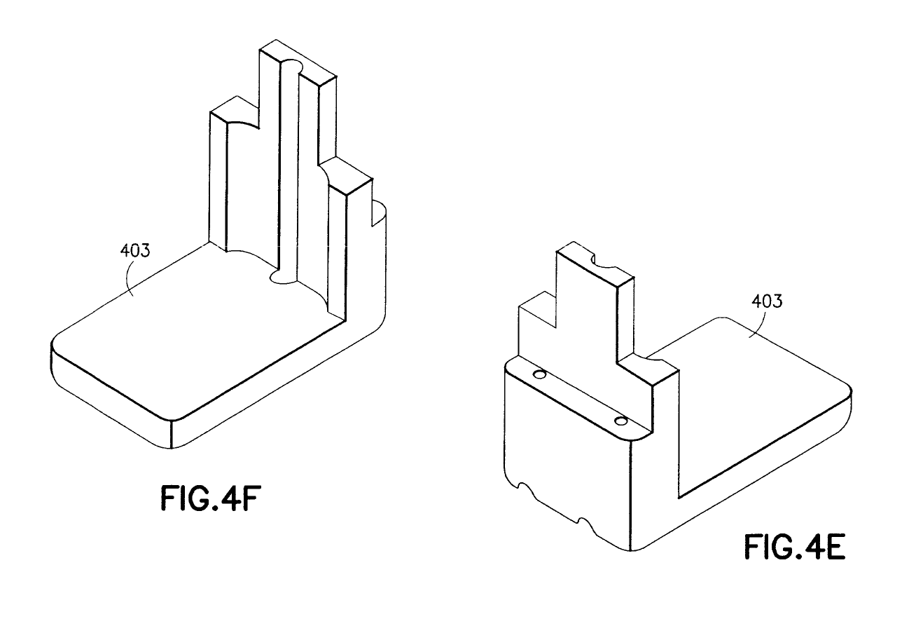

Reference will now be made to FIGS. 4A-4F, which show a status communication system according to another embodiment of the present invention. As seen in these Figs., body 403 may include two apertures 430A, 430B for holding therein two status communicators (not shown).

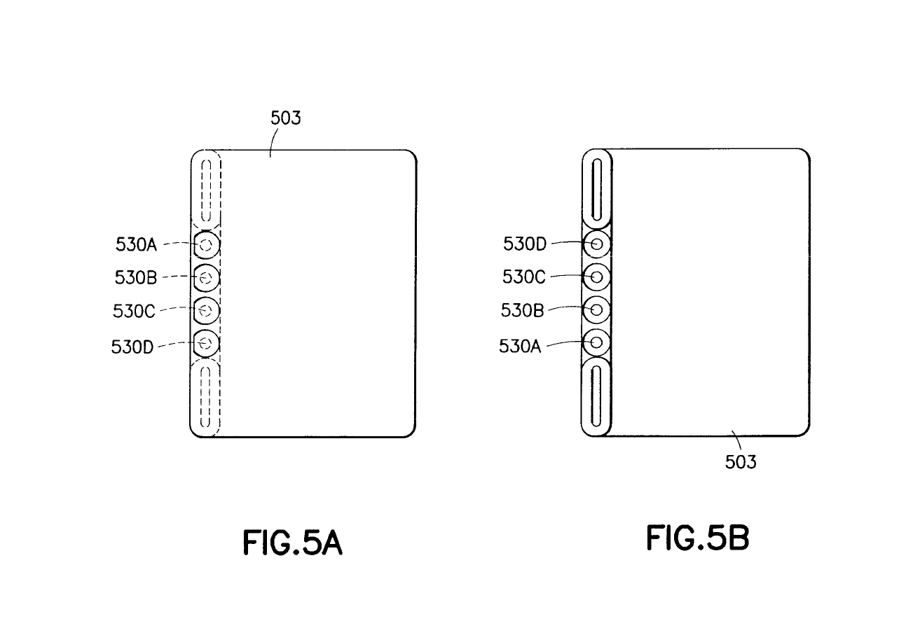

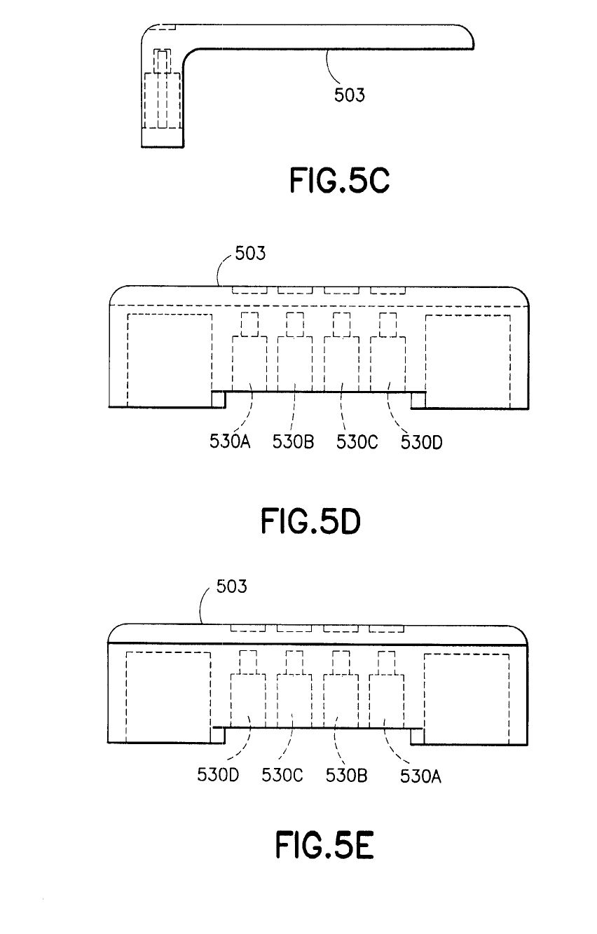

Reference will now be made to FIGS. 5A-5G, which show a status communication system according to another embodiment of the present invention. As seen in these Figs., body 503 may include four apertures 530A-530D for holding therein four status communicators (not shown).

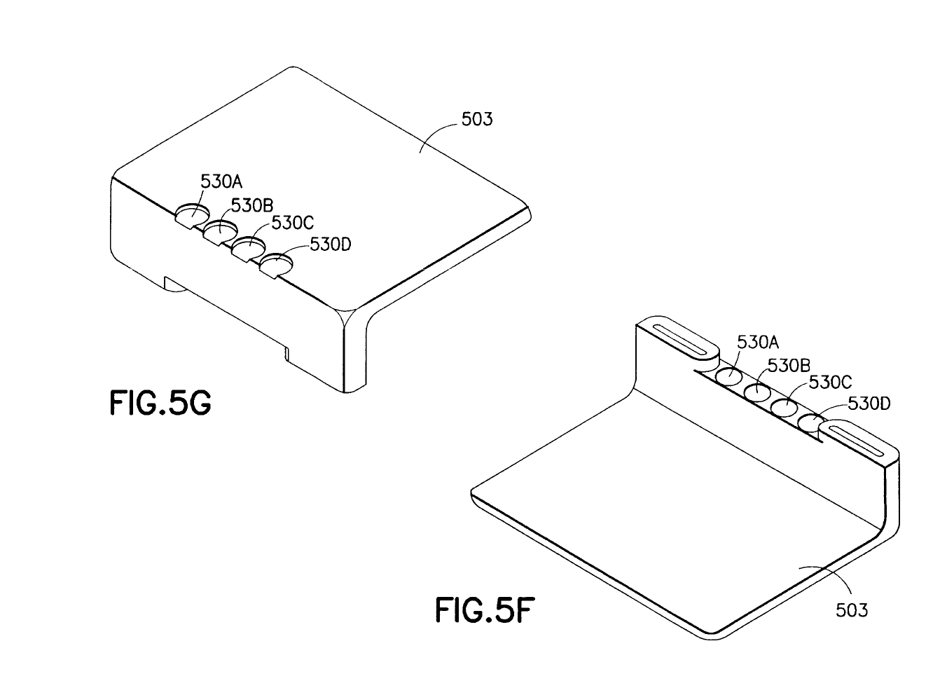

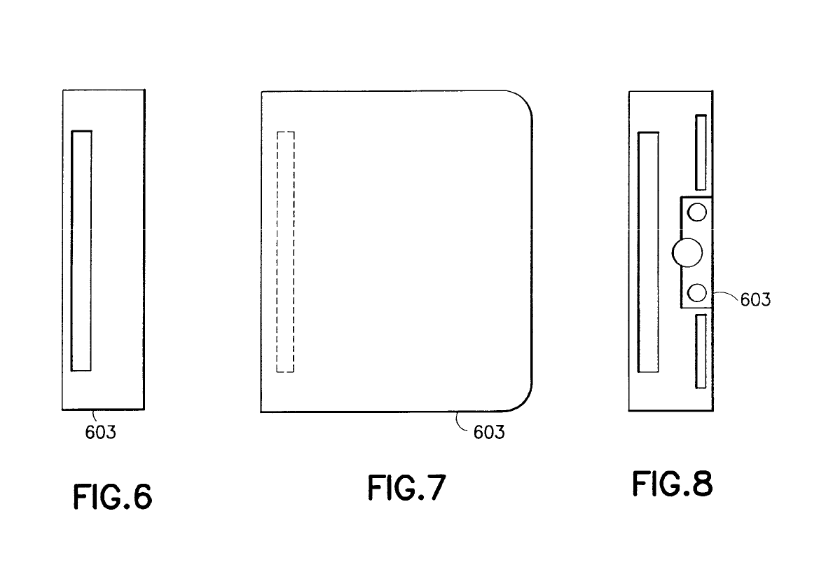

Reference will now be made to FIGS. 6-8, which show a status communication system according to another embodiment of the present invention. As seen in these Figs., body 603 may have thereon a label providing any desired safety/operating information.

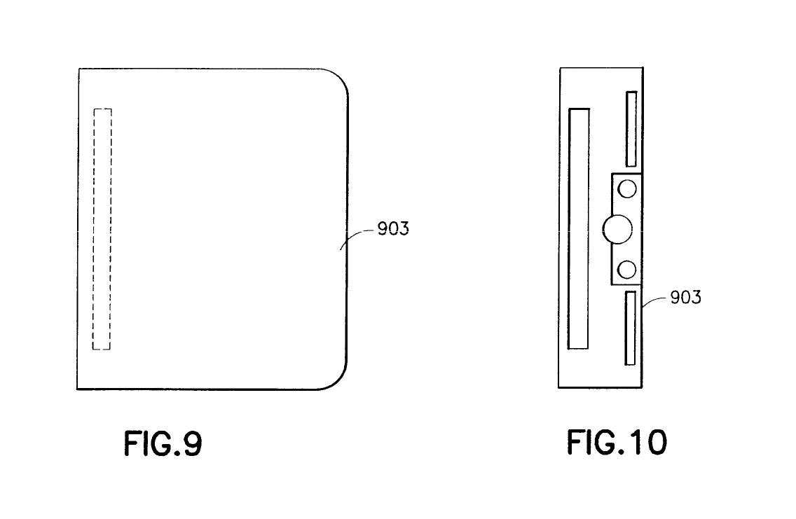

Reference will now be made to FIGS. 9 and 10, which show a status communication system according to another embodiment of the present invention.

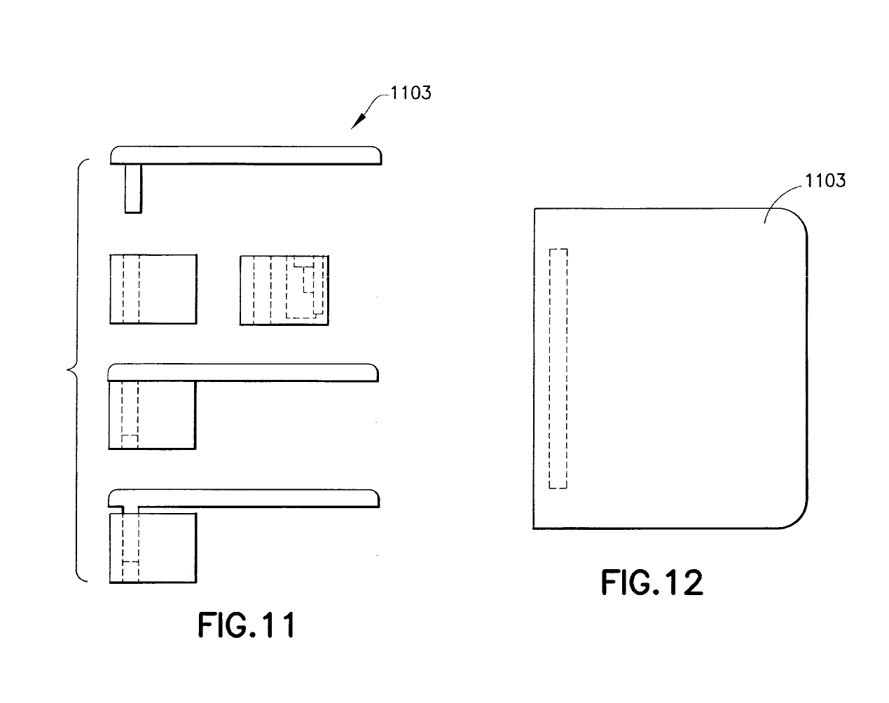

Reference will nova be made to FIGS. 11 and 12, which show a status communication system according to another embodiment of the present invention. As seen in these Figs., body 1103 may be assembled from a plurality of components, e.g., to provide for adjustability.

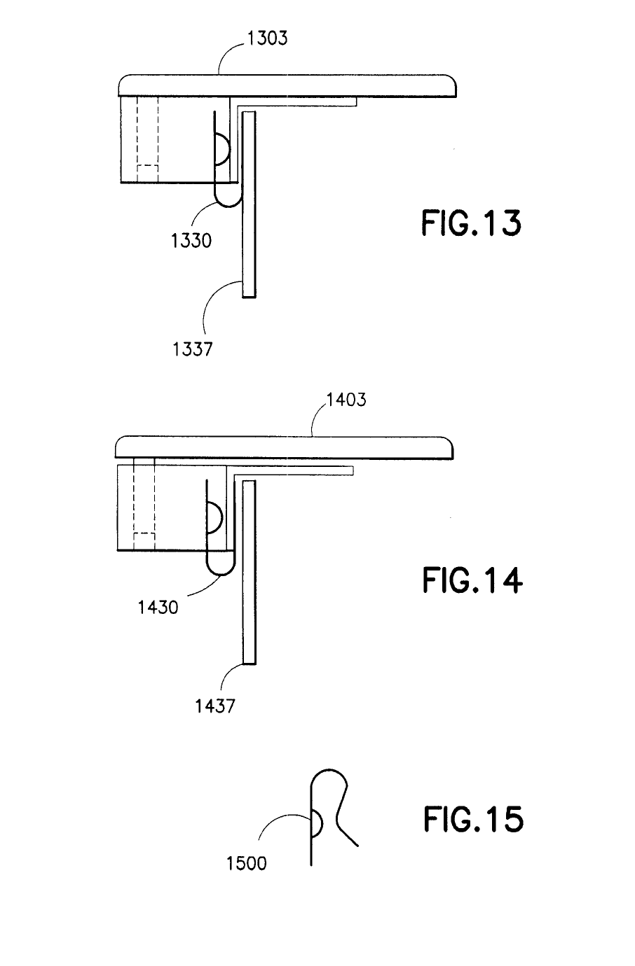

Reference will now be made to FIG. 13, which shows a status communication system according to another embodiment of the present invention. As seen in these Figs., body 1303 may be attached to lip portion 1337 of an electric meter box using clip 1330 (while one clip is shown in this example, any desired number and type of clip(s) may be utilized).

Reference will now be made to FIG. 14, which shows a status communication system according to another embodiment of the present invention. As seen in these Figs., body 1403 may be attached to lip portion 1437 of an electric meter box using clip 1430 (while one clip is shown in this example, any desired number and type of clip(s) may be utilized).

Reference will now be made to FIG. 15, which shows an example type of clip 1500 which may be used in the attachment to an electric meter box of a status communication system.

As described herein, various embodiments of the present invention provide a mechanism to gain access to a device inside of an electrical distribution/equipment control box (e.g., for communication of status such as for indicating and/or monitoring purposes) such that the electrical distribution/equipment control box is left unaltered (in addition, this may be carried out in a simple, low cost manner).

Further, as described herein, various embodiments of the present invention may provide a way to route, for example, an optical (visible light or invisible light—such as infra-red) or other (e.g., audible) status communicator device to the outside of a box-like housing (e.g., a container made of any material, including (without limitation) a metallic or non-metallic material) without puncturing or violating the integrity of the housing. In one example, the mechanical connection to the housing may be via spring (e.g., a spring clip). In another example, the mechanical connection to the housing may alternatively (or additionally) be via one or more threaded attachments and/or one or more adhesives. In another example, a minimal number of loose parts may be utilized. The connection between the status communicator and the device whose status is being indicated/monitored by the status communicator may utilize, for example, electricity or light (visible light or invisible light—such as infra-red). In one example, the status communication device may be weather resistant, clear (or at least partially clear) and large enough to accept an instruction/warning label along with one or more status communicators. While the overall dimensions may, of course, vary as desired, in one example the front surface of the status communication device may be “low-profile”. Further, in another example, the status communication device may be economical and easy to install (with, in one example, the ability to be removed and/or relocated).

Further, still, as described herein, various embodiments of the present invention may provide (using conventional materials) a clip-on status communication module (including label holder and one or more indicator lenses). In one example, the communication module may have a spring attachment and a port for one standard LED (Light Emitting Diode or Fiber Optic cord)—of course, any desired number of ports and/or LED's or Fiber Optics may be utilized. The body of the communication module may be made, for example, at least in part from clear polymer and may be configured so as to attach to the lid (e.g., moveable lid) of an electrical distribution/equipment control box. In one example, a connecting wire of small gauge may be fed through the gap between the electrical distribution/equipment control box case and the electrical distribution/equipment control box lid, with the wire ultimately making an attachment to a device within the electrical distribution/equipment control box. In another example, the status communication module body may have four LED receptacles and may be designed to accept the LED's and a fiber optics cable—of course, any desired number of ports and/or LED's may be utilized. In one example, one or more parts may be injection molded. In another example, one or more parts may be vacuum formed. In another example, one or more parts may be made by extrusion. In one example, the device to be monitored may be configured with a universal LED/Fiber Optic driver and/or may have one or more electrical output wires providing for bi-directional status.

While a number of embodiments of the present invention have been described, it is understood that these embodiments are illustrative only, and not restrictive, and that many modifications may become apparent to those of ordinary skill in the art. For example, the present invention may be used to communicate the status of any desired device(s) including, but not limited to: test equipment, surge protection devices (suppressors, arrestors, etc.). Further, various embodiments of the present invention may be utilized to bring one or more status communicators to the outside of any desired container (not just, for example, the electric meter box described herein) without altering (e.g., drilling) the container. Further, various embodiments of the present invention may be utilized in field retrofit circumstances (which may not be conducive to extensive in field modifications). Further, various embodiments of the present invention may be utilized for either permanent applications (e.g., where the intention is to leave the status communication system in place indefinitely) or temporary applications (e.g., where the intention is to remove the status communication system at a later date). Further, the present invention may be used to communicate the status of any desired system (e.g., electrical, fluid, gaseous, mechanical, etc.). Further still, clear polymer and/or glass may be utilized in configurations where optical transfer is of importance—of course, any non-transparent material(s) may be used instead of or in association with a clear material. Further still, consumers and/or technicians can observe the status of the unseen monitored device by observing the status communication device located on the outside of the electrical distribution/equipment control box (e.g., on the lid or door portion of the electrical distribution/equipment control box). Further still, the status communication device may be attached to the lid portion of the electrical distribution/equipment control box, the case portion of the electrical distribution/equipment control box, or any other desired attachment point or position (commensurate with the dimensions of the electrical distribution/equipment control box and the status communication device). Further still, two-way communications with the monitored device may be provided (e.g., two-way communications via one or more electric wires and/or one or more fiber optic cables). Further still, any steps relating to manufacture and/or use may be performed in any desired order (and any desired steps may be deleted and/or any desired steps may be added).

What is claimed is:

1. A status communication system associated with an electrical distribution/equipment control box having a case portion and a movable lid portion, comprising:
a body;
a status communicator attached to the body;
a communication clement having at least a first end and a second end, wherein the first end of the communication element is operatively connected to the status communicator; and
an attachment mechanism:
wherein the second end of the communication element is operatively connected to a status communicator driving mechanism inside of the case portion of the electrical distribution/equipment control box;
wherein a part of the communication element is disposed between the case portion of the electrical distribution/equipment control box and the moveable lid portion of the electrical distribution/equipment control box when the communication element is operatively connected to the status communicator and the status communicator driving mechanism and the movable lid portion of the electrical distributing,n/equipment control box is in a closed position on the case portion of the electrical distribution/equipment control box; and
wherein the attachment mechanism attaches the body to the electrical distribution/equipment control box at a position such that a state of the status communicator can be discerned by a person without opening the moveable lid portion of the electrical distribution/equipment control box.

2. The system of claim 1, wherein the body is formed at least in part from plastic.

3. The system of claim 1, wherein the body is formed at least in part from metal.

4. The system of claim 1, wherein the body is formed at least in part from glass.

5. The system of claim 1, wherein the status communicator outputs visible light.

6. The system of claim 1, wherein the status communicator outputs infra-red light.

7. The system of claim 1, wherein the status communicator outputs radio frequency.

8. The system of claim 1, wherein the status communicator outputs sound.

9. The system of claim 1, wherein the status communicator outputs vibration.

10. The system of claim 1, wherein the status communicator outputs smell.

11. The system of claim 1, wherein the status communicator outputs a trigger signal.

12. The system of claim 1, wherein the communication element comprises at least one electrical wire.

13. The system of claim 1, wherein the communication element comprises at least one fiber optic cable.

14. The system of claim 1, wherein the communication element comprises at least one light pipe.

15. The system of claim 1, wherein the communication element comprises a flexible circuit board.

16. The system of claim 1, wherein the communication element comprises a hollow tube.

17. The system of claim 1, wherein the moveable lid portion of the electrical distribution/equipment control box comprises a lip and the attachment mechanism attaches the body to the lip of the moveable lid portion of the electrical distribution/equipment control box.

18. The system of claim 17, wherein the attachment mechanism comprises at least one clip.

19. The system of claim 17, wherein the attachment mechanism comprises at least one adhesive.

20. The system of claim 17, wherein the attachment mechanism comprises at least one threaded fastener.

21. The system of claim 17, wherein the attachment mechanism comprises at least one magnet.

22. A method for indicating a status of a device disposed at least partially inside an electrical distribution/equipment control box having a case portion and a moveable lid portion, comprising:
providing a body having a status communicator attached to the body;
operatively connecting a communication element between the status indicator and a status communicator driving element inside of the case portion of the electrical distribution/equipment control box, wherein a first end of the communication element is operatively connected to the status communicator and a second end of the communication element is operatively connected to the status communicator driving mechanism; and
attaching the body to the electrical distribution/equipment control box;
wherein a part of the communication element is disposed between the case portion of the electrical distribution/equipment control box and the moveable lid portion of the electrical distribution/equipment control box when the communication element is operatively connected to the status communicator and the status communicator driving mechanism and the moveable lid portion of the electrical distribution/equipment control box is in a closed position on the case portion of the electrical distribution/equipment control box; and
wherein the body is attached to the electrical distribution/equipment control box at a position such that a state of the status communicator can be discerned by a person without opening the moveable lid portion of the electrical distribution/equipment control box.
